(19) United States
(12) Patent Application Publication
(10) Pub. No.: US 2010/0097362 A1
(43) Pub. Date: Apr. 22, 2010

(54) DISPLAY APPARATUS INCLUDING PASSIVE MATRIX DISPLAY ELEMENT

(75) Inventor: Yuji Ueno, Inagi (JP)

Correspondence Address: GREER, BURNS & CRAIN, 300 S WACKER DR, 25TH FLOOR, CHICAGO, IL, 60606, US

(73) Assignee: FUJITSU FRONTECH LIMITED, Tokyo (JP)

(21) Appl. No.: 12/649,042

(22) Filed: Dec. 29, 2009

Related U.S. Application Data
(63) Continuation of application No. PCT/JP2007/001497, filed on Dec. 28, 2007.

(51) Int. Cl. G09G 3/36; G09G 5/00

(52) U.S. Cl. 345/209; 345/96

(57) ABSTRACT

A display having a passive matrix display element and capable of supporting full-color display includes a passive matrix display element 10 composed of a memory display material, a row driver 26 for driving the scan electrode of the display element and a column driver 27 for driving the data electrode of the display element and further includes an output circuit for outputting only one set of control signals composed of a pulse signal XCLK indicating a clock for retrieving data, a pulse signal LP indicating a latch pulse for data confirmation and a frame signal FR indicating a pulse polarity control signal which are shared by the three primary colors. The output timing of three display driving signals supporting full-color display is set at time intervals indicated by a predetermined setting value. The time intervals can be determined with reference to the temperature-operating time characteristic of a nematic liquid crystal.

### CROSS REFERENCE TO RELATED APPLICATION

This application is a continuation of the PCT application of PCT/JP2007/001497, which was filed on Dec. 28, 2007.

### FIELD

The invention relates to a display apparatus having a passive matrix display element, and more particularly to a display apparatus having a passive matrix display element which comprises a memory-property display material, such as a cohlesteric liquid crystal and the like, and is used for electronic paper and the like.

### BACKGROUND

Recently, the development of electronic paper has been promoted in the industrial field, an educational foundation and the like. As application fields where electronic paper can be used, there are an electronic book, the monitor display apparatus of a mobile terminal set, etc., the display unit of an IC card, etc., and the like and various application forms are proposed and developed in each field. Furthermore, recently, newspaper information has been distributed on the Internet and electronic paper has been focused as an information medium instead of the conventional newspaper.

One leading method of electronic paper is a method using a cohlesteric liquid crystal and this uses the superior features of a cohlesteric liquid crystal, that is, characteristics of keeping semi-permanent display (memory-property), vivid color display, high contrast and high resolution.

Since the molecule of a cohlesteric liquid crystal forms a helical cohlesteric phase by adding fairly much (several-tens percentage of) chiral additive (chiral material) to a cohlesteric liquid crystal, such a cohlesteric liquid crystal is also called chiral nematic liquid crystal.

FIGS. 1A and 1B illustrate the state of a cohlesteric liquid crystal. As illustrated in FIGS. 1A and 1B, a display element 10 using a cohlesteric liquid crystal includes a top-side substrate 11, a cohlesteric liquid crystal layer 12 and a bottom-side substrate 13. The operational state of a cohlesteric liquid crystal includes a planer state capable of reflecting incident light as illustrated in FIG. 1A and a focal-conic state capable of transmitting incident light as illustrated in FIG. 1B. Both these states are maintained in a state where no voltage is applied, that is, under no electric field. Therefore, a cohlesteric liquid crystal can hold a stable display state.

When the operational state of a cohlesteric liquid crystal is a planer state, light of a wavelength corresponding to the helical pitch of the liquid crystal molecule is reflected. A wavelength λ in which reflection becomes large can be expressed to be n·p (λ=n·p) assuming that the average refractive index of a cohlesteric liquid crystal and its helical pitch are n and p, respectively.

Meanwhile, characteristically the reflection band Δλ of a cohlesteric liquid crystal widely varies depending on the refractive index anisotropy Δn of the liquid crystal.

When the operational state of a cohlesteric liquid crystal is a planer state, it becomes a “light” state because of reflection of incident light, that is, a state capable of displaying white. Meanwhile, when the operational state of a cohlesteric liquid crystal is a focal-conic state, it becomes a “dark” state, that is, a state capable of displaying black. That is because when a light absorptive layer is provided under the bottom-side substrate 13, light transmits through a liquid crystal layer and also it is absorbed by the light absorptive layer.

The driving method of a conventional general display element using a cohlesteric liquid crystal will be explained below.

FIG. 2 is a graph illustrating the voltage-reflectance characteristic of a conventional general cohlesteric liquid crystal.

In the graph illustrated in FIG. 2, the vertical and horizontal axes of the graph indicate the reflectance (%) of a cohlesteric liquid crystal and the voltage value (V) of a pulse voltage applied to between electrodes pinching a cohlesteric liquid crystal with a predetermined pulse width, respectively.

A curve P indicated by a solid line indicates the voltage-reflectance characteristic of a cohlesteric liquid crystal whose initial state is a planer state and a curve FC indicated by a broken line indicates the voltage-reflectance characteristic of a cohlesteric liquid crystal whose initial state is a focal-conic state where incident light is transmitted.

When a relatively intense electric field is generated in the cohlesteric liquid crystal by applying a predetermined high voltage VP100 (for example, ±36V) to between electrodes pinching the cohlesteric liquid crystal, the helical structure of the cohlesteric liquid crystal is completely released and it moves to a homeotropical state where all molecules follow the direction of the electric field.

When the electric field in the cohlesteric liquid crystal is suddenly reduced to almost zero by suddenly reducing an applied voltage from VP100 to a predetermined low voltage (for example, VF0=±4V) while the molecules of the crystal liquid is in a homeotropical state, the helical axis of the cohlesteric liquid crystal becomes perpendicular to the electrode and transits to a planer state where light corresponding to the helical pitch is selectively reflected.

Meanwhile, a relatively weak electric field is generated in the cohlesteric liquid crystal by applying a predetermined low voltage VF100b (for example, ±24V), it enters a state where the helical structure of the cohlesteric liquid crystal molecule is not completely released. When the electric field in the liquid crystal is suddenly reduced to almost zero by suddenly reducing the applied voltage from VF100b to low voltage VF0 in this state or when the electric field is slowly eliminated by applying an intense electric field, the helical axis of the liquid crystal molecule becomes parallel to the electrode, namely, it enters the above-described focal-conic state where the incident light is transmitted.

When the electric field is suddenly eliminated by applying an intermediately intense electric field, gradation display becomes possible since the above-described planer state where the incident light is reflected and the above-described focal-conic state where the incident light is transmitted are mixed. Conventionally, a liquid crystal display apparatus displays images by using reflective and absorptive functions of the incident light, as described above.

The principle of the driving method based on the above-described voltage response characteristic will be explained in more detail with reference to FIGS. 3A through 3C.

FIG. 3A illustrates a pulse response characteristic in the case where the pulse width of a voltage pulse is several tens ms in the cohlesteric liquid crystal, FIG. 3B illustrates a pulse response characteristic in the case where the pulse width of a voltage pulse is 2 ms and FIG. 3C illustrates a pulse response characteristic in the case where the pulse width of a voltage pulse is 1 ms in the cohlesteric liquid crystal. A voltage pulse applied to the cohlesteric liquid crystal is indicated on the top-side of each of FIGS. 3A through 3C and a voltage-reflectance characteristic on the bottom side. The vertical and horizontal axes of FIGS. 3A through 3C indicate a reflectance (%) and a voltage (V), respectively. For the drive pulse of the cohlesteric liquid crystal, a combination of positive and negative pulses is used. As well known, when a fixed pulse whose polarity is not inverted continues to be applied to the cohlesteric liquid crystal, the degradation of the cohlesteric liquid crystal, due to polarization is induced. However, such degradation can be prevented by using a combination of positive and negative pulses.

In FIG. 3A, when the pulse width of a voltage pulse applied to the cohlesteric liquid crystal is as large as several tens ms, in the case where the initial state is a plenary state, it enters a focal-conic state when the voltage is increased to a certain level, as illustrated by a solid line, and it returns to a plenary state when the voltage is further increased. However, as illustrated by a broken line, in the case where the initial state is a planer state, it gradually transits to a planer state as the pulse voltage is increased.

When the pulse width of a voltage applied to the cohlesteric liquid crystal is large, the pulse voltage in which it always enters a planer state regardless of whether it is either a planer or focal-conic state is ±36V in FIG. 3A. When an intermediate pulse voltage is applied, gradation display can be obtained since planer and focal-conic states are mixed in the cohlesteric liquid crystal.

Meanwhile, when the pulse width of a voltage pulse applied to the cohlesteric liquid crystal is as small as 2 ms, as illustrated in FIG. 3B, in the case where the initial state is a planer state, the reflectance does not change when the pulse voltage is 10V. Since planer and focal-conic states are mixed when the pulse voltage is more than 10V, the reflectance degrades. This amount of degradation of the reflectance increases as the applied voltage increases. However, when the applied voltage becomes more than 36V, the amount of degradation of the reflectance becomes constant. Such a characteristic in the cohlesteric liquid crystal also applies to a state where planer and focal-conic states are mixed in the initial state. Therefore, when in the case where the initial state is a planer state, the pulse width is 2 ms and the voltage pulse whose pulse voltage is 20V is applied once, the reflective index degrades somewhat. Therefore, in a state where planer and focal-conic states are mixed (that is, a state where the reflectance degrades somewhat), the pulse width of the voltage pulse is 2 ms and also the reflectance of the cohlesteric liquid crystal can be further degraded by further applying the voltage pulse whose pulse voltage is 20V. The reflectance can be degraded to a predetermined value by repeating the sequence of the above operations.

As illustrated in FIG. 3C, when the pulse width further decreases to 1 ms, as in the case where the pulse width is 2 ms, the reflectance of the cohlesteric liquid crystal can be further degraded by further applying the voltage pulse to the cohlesteric liquid crystal. In this case, the degradation rate of the reflectance becomes smaller than that in the case where the pulse width is 2 ms.

Judging from the above, if a pulse of 36V is applied with a pulse width of several tens ms, the cohlesteric liquid crystal enters a planer state. If a pulse of between ten several V and 20V is applied, it enters a state where planer and focal-conic states are mixed and the reflectance degrades. This amount of degradation of the reflectance relates to the accumulation time of the pulse.

Currently, various driving method for realizing multi-gradation display using the cohlesteric liquid crystal are proposed and developed. These can be roughly classified into two of a dynamic driving method (for example, see document 1) and a conventional driving method (see Non-patent document 1).

Since the drive waveform of the dynamic driving method is complex, the dynamic driving method requires a complex control circuit and a driver IC and also requires a low-resistance transparent panel electrode. Therefore, the manufacturing cost becomes high. Furthermore, the power consumption is also large.

Non-patent document 1 discloses the conventional driving method of gradually driving the cohlesteric liquid crystal from a planer state to a focal-conic state or from a focal-conic state to a planer state, at the fairly high speed of a semi-moving image rate by adjusting the application times of a short voltage pulse, using an accumulation time peculiar to the cohlesteric liquid crystal.

In the driving method disclosed in Non-patent document 1, since the driving speed is at the high speed of a semi-moving image rate, the driving voltage is set to 50 through 70V. Therefore, the cost of the circuit becomes high. Furthermore, in the “two phase cumulative drive scheme” described in Non-patent document 1, accumulation times in two ways of an accumulation time to a planer state and an accumulation time to a focal-conic state are used by using two stages of a “preparation phase” and a “selection phase”. Therefore, the display quality of display images cannot be improved. Furthermore, since a fine voltage pulse is frequently applied, the power consumption of the driver circuit becomes large.

Patent documents 2 and 3 disclose a fast-forward mode driving method based on the reset to a focal-conic state. In this driving method, fairly high contrast can be obtained compared with the above-described driving method. However, in the case of a general-purpose STN driver IC, since writing after the reset requires a supply-difficult high voltage and also becomes cumulative writing in which it is transited in the direction of a planer state, cross-talk to a semi-selected/non-selected pixel becomes a problem. Besides, since a fine pulse is frequently applied in this driving method too, the power consumption becomes large.

When gradation is set using an accumulation time in the conventional driving method, the differentiation of a pulse width is also possible in addition to the adjustment of application times of a short pulse as described above. Thus, the differentiation of a pulse width is effective in suppressing the power consumption than the adjustment of application times of a short pulse. In the following explanation, a method for and differentiating a pulse width and setting gradation by changing an accumulation time is called PWM (pulse width modulation).

Patent document 4 discloses the circuit composition of a method for applying positive and negative pulses, whose pulse widths are different, to a liquid crystal display as a pulse voltage although no cohlesteric liquid crystal is used.

Each of FIGS. 4A through 4C illustrates one example of a voltage pulse whose width is different disclosed in Patent document 4. In these examples, the pulse width is made longer in the descending order of FIGS. 4A, 4B and 4C.

The voltage pulses illustrated in FIGS. 4A through 4C have positive and negative pulses whose per unit pulse length are the same and whose widths are different. The degradation due to the polarization of the cohlesteric liquid crystal can be prevented by applying such a polarity-conversion voltage pulse.

As described above, as methods for differentiating gradation by differentiating the application cumulative time of a voltage pulse applied to the cohlesteric liquid crystal, a method for differentiating the application times of a short voltage pulse and a method for differentiating the width of an applied voltage pulse (PWM method) are well known.

In the method differentiating gradation by differentiating the application cumulative time of a voltage pulse applied to the cohlesteric liquid crystal, voltages as illustrated in FIGS. 3B and 3C are applied. In the method for differentiating the application times of a short voltage pulse, a voltage as illustrated in FIG. 5 is applied to a pixel.

In the cohlesteric liquid crystal, when a large voltage is applied, the state changes regardless of the polarity of the applied voltage. In the liquid crystal display apparatus using the cohlesteric liquid crystal, a scan line extending in the horizontal direction is written one by one and the shifting operation of a written scan line is repeated. Therefore, a voltage at a ground level and an intermediate voltage (for example, 15V) are applied to a selected scan line and other non-selected scan lines, respectively. Meanwhile, although a pulse of a large voltage (20V) is applied to a data line extending in the vertical direction. In this case, if the potential of parts other than the pulse width is assumed to be ground potential (GND), a large voltage in inverse polarity (−15V) is applied to a pixel in the non-selected scan line and the state of the cohlesteric liquid crystal changes.

In order to prevent such a state change of the liquid crystal, in the case of a liquid crystal display apparatus using the cohlesteric liquid crystal, as illustrated in FIG. 5, a base voltage of +10V and a pulse voltage of +20V are used in a positive-polar phase, and a base voltage of −10V and a pulse voltage of −20V are used in a negative phase. Thus, either +5V or −5V is applied to the pixel of a non-selected scan line and there is no change in the state of the liquid crystal. In a selected scan line, either +20V or −20V is applied to a pulse part and either +10V or −10V is applied to a base part other than it.

Patent document 1: Japanese Laid-open Patent Publication No. 2001-228459
Patent document 2: Japanese Laid-open Patent Publication No. 2000-147466
Patent document 3: Japanese Laid-open Patent Publication No. 2000-171837
Patent document 4: Japanese Laid-open Patent Publication No. H4-62516
Non-patent document 1: Y. M. Zhu, D. K. Yang, “Cumulative Drive Schemes for Bistable Reflective Cohlesteric LCDs.”, SID 98 DIGEST, pp 781-801 (1998)

When the above-described display apparatus having a passive matrix display element is composed in such a way as to enable full-color display, a liquid crystal panel for each color of RGB is required. Therefore, three times of drivers as that in the case of non-color display are required. In this case, the number of components increases too much and the cost becomes high.

This problem will be explained in more detail below.

FIG. 12 is a time chart indicating the sequence of the output signal of a general passive matrix driver.

In FIG. 12, a pulse signal XCLK indicates a clock for retrieving data (see FIG. 6). A pulse signal LP indicates a data confirmation latch pulse. A frame signal FR repeating cyclic rise and fall indicates a pulse polarity control signal for recovering time degradation peculiar to a liquid crystal by inverting the polarity of the applied voltage. A display apparatus drive signal/DSPOF (DSPOF bar) is the drive signal of a liquid crystal display apparatus and more particularly it indicates the inverse signal of a compulsory off signal of the applied voltage (signal for switching off the applied voltage, that is, DSPOF) (see FIG. 6). Furthermore, a data signal OUT indicates image data displayed on the liquid crystal display apparatus.

Since the conventional liquid crystal display apparatus (display apparatus having a passive matrix display element) capable of supporting full-color display requires a liquid crystal panel for each color of RGB, three times of drivers as that in the case of non-color display, for outputting one set of the above-described signals (more particularly, three) are required. Namely, the number corresponding to three primary colors reflected by liquid crystal molecules, of drivers are required. Therefore, three times the number for one driver, of components are required. Therefore, the manufacturing cost (variable cost) becomes high.

Furthermore, since in the conventional liquid crystal display apparatus capable of supporting full-color display, the above-described three drivers corresponding to three primary colors to be reflected are disposed in parallel and simultaneously driven, the difference in temperature-operating time characteristic of the liquid crystals corresponding to the three primary colors is not taken into consideration, thereby causing color unevenness (chromatic aberration).

If a time difference is set in the driver output instead of simultaneously driving the above-described three drivers in order to solve such a problem, an extra circuit is required.

If the above-described three drivers are simultaneously driven, much electric current is required at the initial time of the liquid crystal driving and under shoot in which a voltage (20V) for driving the liquid crystal temporarily degrades occurs. Therefore, the display contrast becomes unstable.

It is an object of the present invention to provide a display apparatus having a passive matrix display element capable of simplifying the configuration of the driver circuit and thereby reducing the number of components from the viewpoint of solving the above-described problem in the drive control device of a passive matrix cohlesteric liquid crystal display element enabling full-color display.

It is another object of the present invention to provide a display apparatus having a passive matrix display element provided with the drive control device of a passive matrix cohlesteric liquid crystal display element enabling full-color display and capable of solving the color shift/color unevenness (chromatic aberration) of a display image, due to the difference in temperature-operating time characteristic of each liquid crystal corresponding to each of the three reflected primary colors.

### SUMMARY

In order to attain the above-described purposes, the display apparatus of the present invention includes a row driver for driving the scan electrode of the display element and a column driver for driving the data electrode of the display element. The display apparatus further includes a unit for outputting one set of control signals composed of a pulse signal XCLK indicating a clock for retrieving data of the display element, a pulse signal LP indicating a data confirmation latch pulse and a frame signal FR indicating a pulse polarity control signal and a unit for sequentially outputting a display apparatus drive signal (/DSPOF-R), a display apparatus drive signal (/DSPOF-G) and a display apparatus drive signal (/DSPOF-B) as three display apparatus drive signals corresponding to full-color display each with different timing and also inputting each of them into each of the three liquid crystal display apparatuses corresponding to three liquid crystal display panels for full-color display.

Since by such a configuration, only one set of control signals excluding three display apparatus drive signals, that is, one set of control signals composed of a pulse signal XCLK, a pulse signal LP and a frame signal FR is provided, the configuration of the driver circuit can be simplified, the number of components can be reduced and also the three display apparatus drive signals supporting full-color display can be independently secured, the control timing for full-color display can be optimized and a display apparatus capable of solving the color shift/color unevenness (chromatic aberration) of a display image can be provided.

Furthermore, in the display apparatus, each of the output time interval between the display apparatus drive signal (/DSPOF-R) and the display apparatus drive signal (/DSPOF-G) and the output time interval between the display apparatus drive signal (/DSPOF-G) and the display apparatus drive signal (/DSPOF-B) can be set.

Since by such a configuration, the output time intervals between the three display apparatus drive signals supporting full-color display can be freely set, the control timing for full-color display can be adjusted and a display apparatus capable of solving the color shift/color unevenness (chromatic aberration) of a display image can be provided.

Furthermore, in the display apparatus, each of the three display apparatus drive signals starts or stops drive of a corresponding liquid crystal display apparatus, corresponding to the two high and low values of the signal.

By such a configuration, full-color display can be controlled using just the three display apparatus drive signals supporting full-color display and a display can be provided at a low manufacturing cost.

Furthermore, in the display apparatus, each of the three display apparatus drive signals validates a voltage applied to its corresponding liquid crystal display apparatus when the signal is high and compulsorily eliminates a voltage applied to its corresponding liquid crystal panel when the display drive signal is low.

By such a configuration, full-color display can be surely controlled using just the three display apparatus drive signals supporting full-color display and a reliable display apparatus can be provided at a low manufacturing cost.

Furthermore, in the display apparatus, the setting of the output time intervals can be determined with reference to the temperature-operating time characteristic of a nematic liquid crystal used in the liquid crystal display apparatus and the ambient temperature in the setting environment of the liquid crystal display apparatus.

By such a configuration, the output time intervals between the three display apparatus drive signals supporting full-color display can be accurately determined on the basis of the temperature-operating time characteristic of a nematic liquid crystal and the ambient temperature in the setting environment of the liquid crystal display apparatus and a display apparatus capable of surely solving the color shift/unevenness (chromatic aberration) of a display image can be provided in conformity with its using environment and the like.

Furthermore, in the display apparatus, the three liquid crystal display panels corresponding to the three liquid crystal display apparatuses controlled by the respective display drive signals are piled on each other.

### BRIEF DESCRIPTION OF THE DRAWINGS

FIG. 1A illustrates the planer state of a cohlesteric liquid crystal;

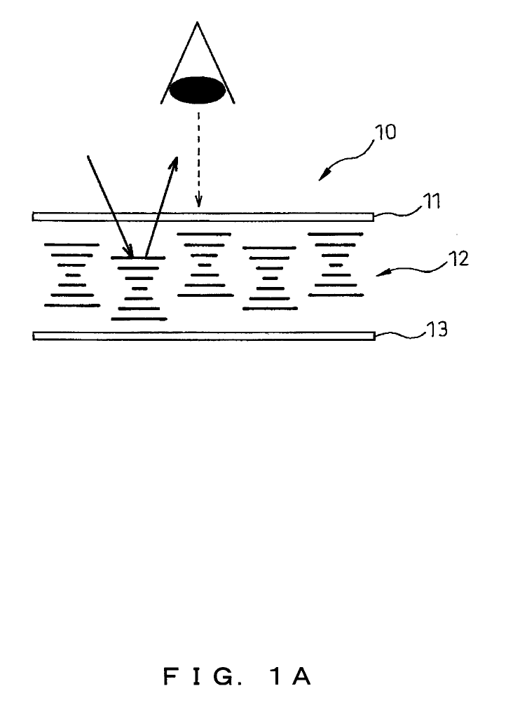

FIG. 1B illustrates the focal-conic state of a cohlesteric liquid crystal;

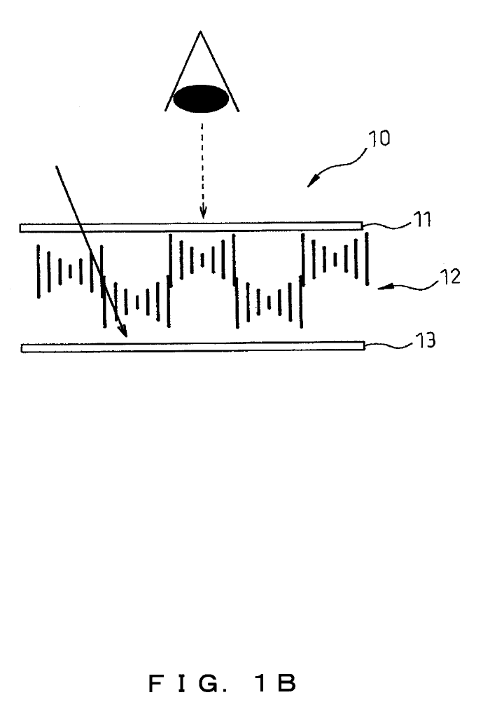

FIG. 2 is a graph illustrating the voltage-reflectance characteristic of a conventional general cohlesteric liquid crystal;

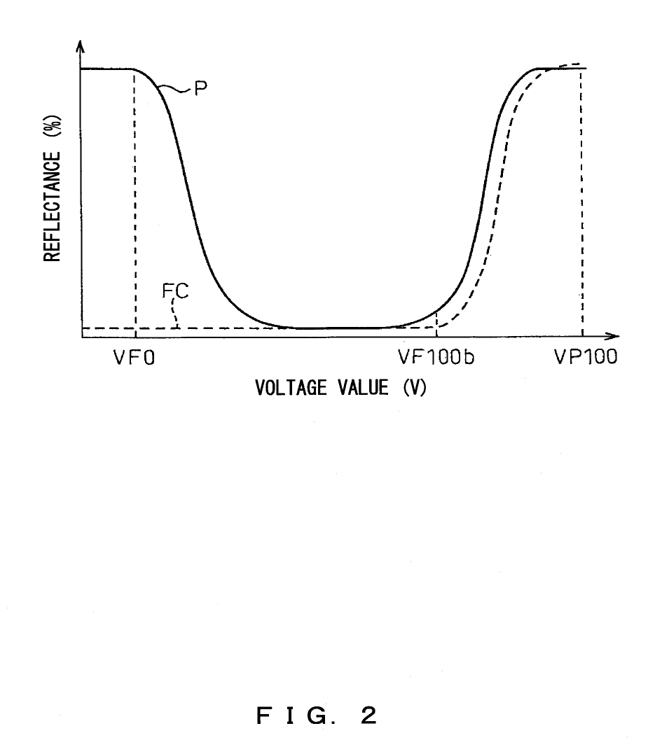

FIG. 3A illustrates the change of a reflectance, by a large voltage applied to a cohlesteric liquid crystal and its broad pulse;

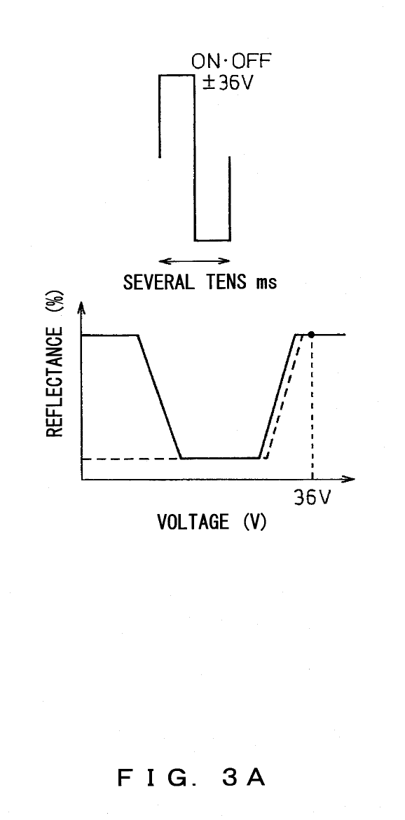

FIG. 3B illustrates the change of a reflectance, by an intermediate voltage applied to a cohlesteric liquid crystal and its narrow pulse;

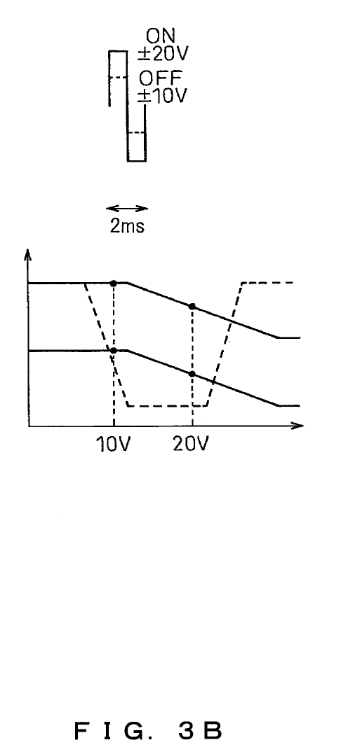

FIG. 3C illustrates the change of a reflectance, by an intermediate voltage applied to a cohlesteric liquid crystal and its narrower pulse;

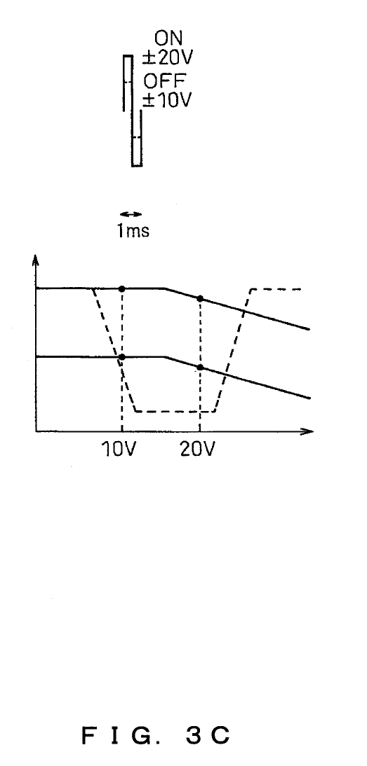

FIG. 4A is a waveform illustrating one example of the case where a symmetrical pulse applied to a liquid crystal is narrow;

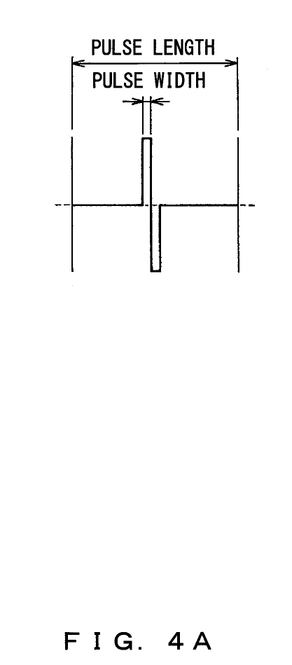

FIG. 4B is a waveform illustrating one example of the case where a symmetrical pulse applied to a liquid crystal is intermediate;

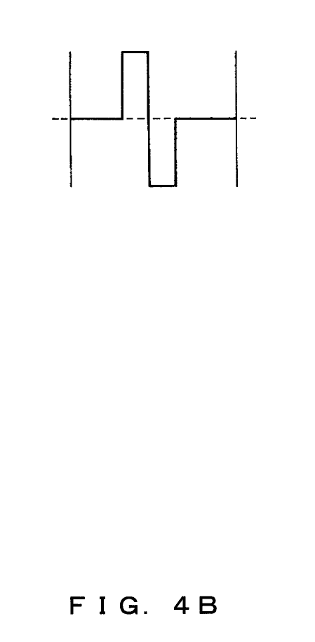

FIG. 4C is a waveform illustrating one example of the case where a symmetrical pulse applied to a liquid crystal is broad;

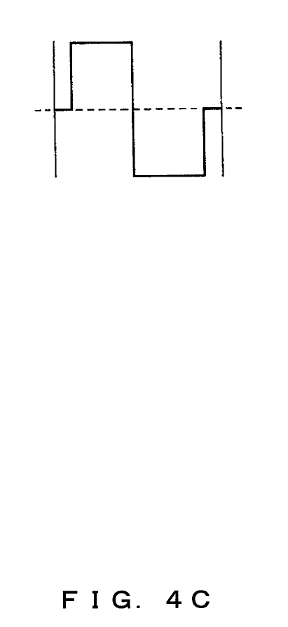

FIG. 5 is a waveform illustrating one example of a symmetrical pulse applied to a cohlesteric liquid crystal;

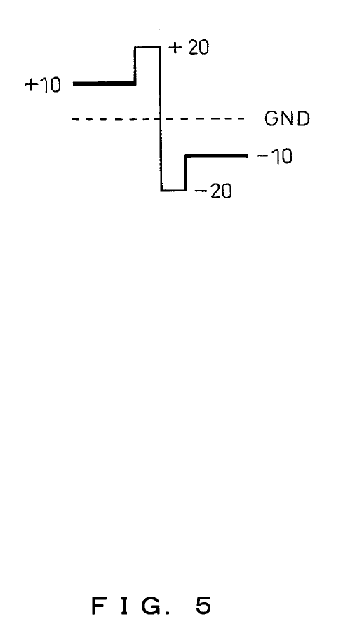

FIG. 6 is a schematic configuration of a display apparatus according to the embodiment of the present invention;

FIG. 7 is a time chart illustrating one example of the drive sequence of a display apparatus according to the embodiment of the present invention;

FIG. 8A is a time chart illustrating one example of the output pulse sequence of a general-purpose segment driver and a general-purpose common driver in a display apparatus;

FIG. 8B illustrates a voltage applied to a liquid crystal with the output pulse illustrated in FIG. 8A;

FIG. 9 is a configuration of a general-purpose passive matrix driver;

FIG. 10A illustrates the output voltage in the segment mode of a general-purpose passive matrix driver;

FIG. 10B illustrates the output voltage in the common mode of a general-purpose passive matrix driver;

FIG. 11 is a rough configuration of a conventional display using a general-purpose passive matrix driver;

FIG. 12 is a time chart illustrating the sequence of the output signal of a general passive matrix driver;

FIG. 13 is a time chart illustrating the sequence of the output signal of the passive matrix driver provided for a display apparatus according to the embodiment of the present invention;

FIG. 14 is a block configuration from the functional point of view, of the driver circuit provided for a display apparatus according to the embodiment of the present invention; and

FIG. 15 is a graph illustrating the temperature-operating time characteristic of a general nematic liquid crystal.

### DESCRIPTION OF EMBODIMENT

The embodiments of the present invention will be explained below with reference to the drawings.

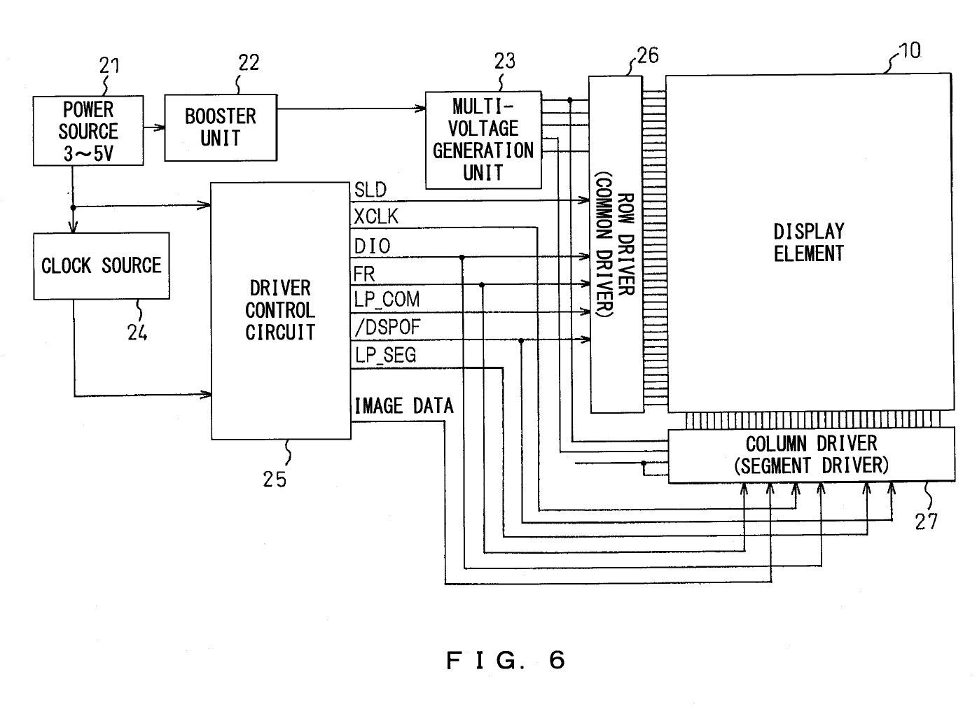

FIG. 6 is a schematic configuration of a display apparatus according to the embodiment of the invention.

A display according to the embodiment includes a passive matrix display element 10 composed of memory display material, such as a cohlesteric liquid crystal and the like, a power source 21 for supplying power to a circuit, a booster unit 22 for boosting the output voltage of the power source 21, a multi-voltage generation unit 23 for branching the output of the booster unit 22 into a plurality of voltage values, a clock source 24 for supplying clocks to a circuit, a driver control circuit 25 for generating a plurality of control signals and image data, a row driver 26 (common driver) for driving a scan line and a column driver 27 (segment driver) for driving a display line.

The operation of a display apparatus according to the embodiment will be explained below.

The display element 10 can be, for example, specified as A4·XGA and have 1024×768 pixels. The power source 21 can output voltage of, for example, 3-5V. The booster unit 22 boosts voltage inputted from the power source 21 up to 36-40V by a regulator, such as a DC-DC converter. The multi-voltage generation unit 23 generates a plurality of voltages supplied from a boosted voltage to the row driver (common driver) 26 and column driver (segment driver) 27.

The clock source 24 outputs clocks used to control each unit of this display apparatus. The driver control circuit 25 outputs a plural types of control signals and controls both the row driver 26 and column driver 27.

Scan line data SLD is latched and sequentially shifted by the row driver 26. A data retrieving clock XCLK is used for the column driver 17 to transfer image data inside.

A frame start signal DIO is a signal to instruct the update of a display line. A pulse polarity control signal FR is a polarity inverted signal of applied voltage.

A scan shift signal LP_COM is a signal to instruct the update of a display line in the row driver 26.

A signal /DSPOF (DSPOF bar) indicates the drive signal of a liquid crystal display apparatus and more particularly is the inverse signal of the compulsory off signal of applied voltage (signal for switching off applied voltage, more specifically, signal DSPOF). A column data latch signal LP_SEG is a signal to instruct the update of a display line in the column driver 27. Image data is inputted to the column driver 27.

The row driver (common driver) 26 drives 768 scan lines and the column driver (segment driver) 27 drives 1024 data lines. Since a different piece of image data is given to each pixel of RGB, the column driver 27 independently drives each data line. The row driver 26 commonly drives lines of RGB. For each of the row driver (common driver) 26 and column driver (segment driver) 27, a general-purpose two-valued output passive matrix driver is used. A widely used driver IC includes a common driver IC and a segment driver IC. Furthermore, the driver IC can be use as both the common and segment drivers, depending on voltage applied to a mode switching terminal.

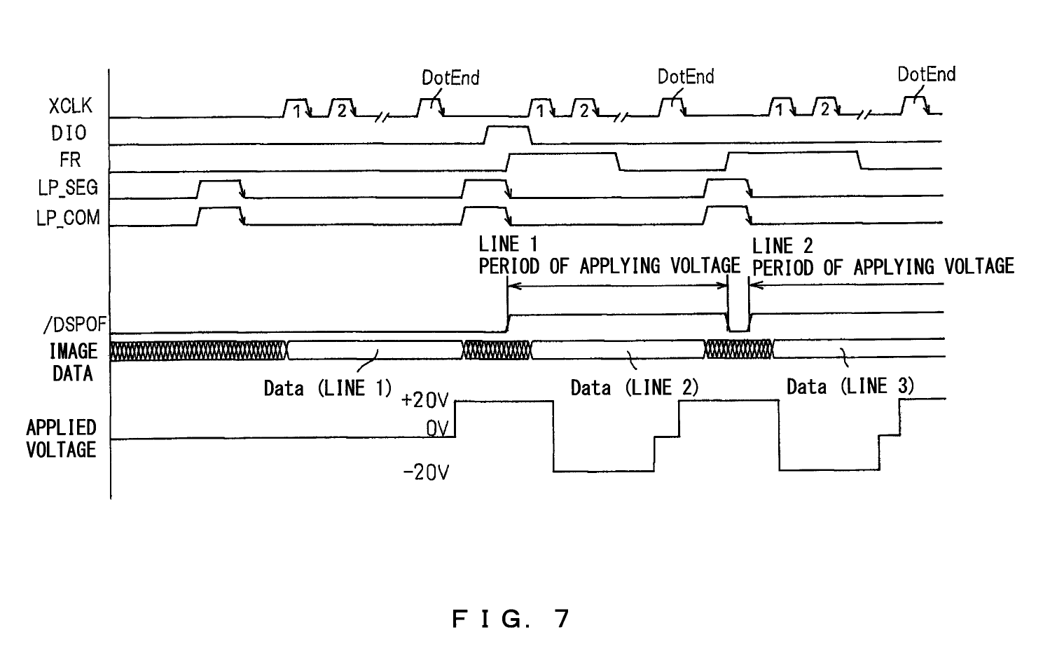

FIG. 7 is a time chart illustrating one example of the drive sequence of a display apparatus according to the embodiment of the present invention.

As illustrated in FIG. 7, data of one line is supplied to the column driver 27 according to the data retrieving clock XCLK after a display line is updated by applying the control signals LP_COM and LP_SEG to a liquid crystal, and the control signals LP_COM and LP_SEG are applied to the liquid crystal again when pixel data of one line is arranged by shifting 1024 pieces of pixel data. Then, the row driver 26 outputs a voltage pulse having a positive phase to one scan line. The column driver 27 outputs a voltage pulse having a positive phase corresponding to image data of one line data to 1024 data lines.

After the application of a pulse having a positive phase is completed, a voltage pulse having a negative phase is applied to the liquid crystal. In parallel with this, as described above, pixel data of one subsequent line is supplied.

Then, by repeating the same process, voltage pulses having positive and negative phases are applied to the full screen according to display data. If a pulse cumulative application time corresponding to a gradation gray level is adjusted by the number of voltage pulses applied to the liquid crystal, the times of voltage pulses applied for each data line is changed. If the pulse cumulative application time is adjusted by the pulse length, the width of a voltage pulse applied to the liquid crystal for each data line is changed.

When all pixels are reset to a planer state, high (for example, 36V) symmetrical voltage broad pulses having positive and negative phases are applied to all pixels of the liquid crystal.

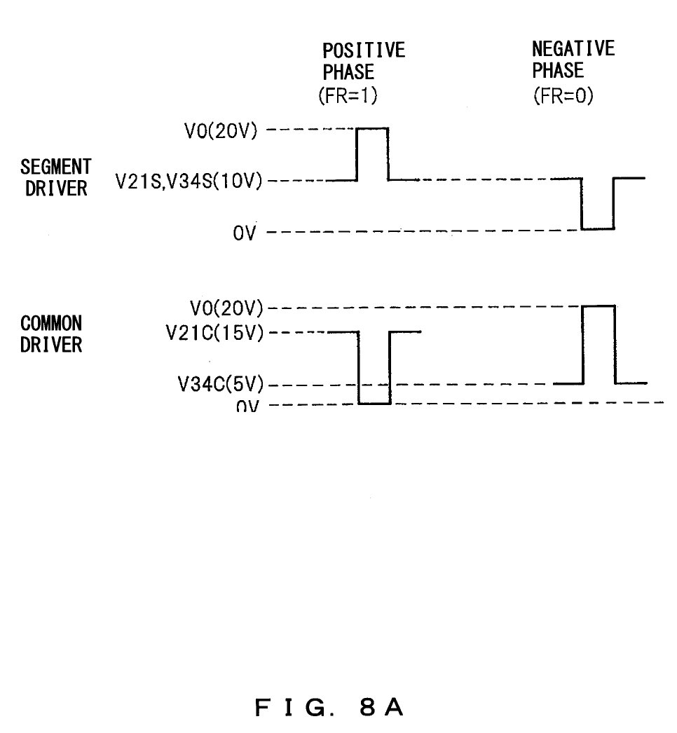

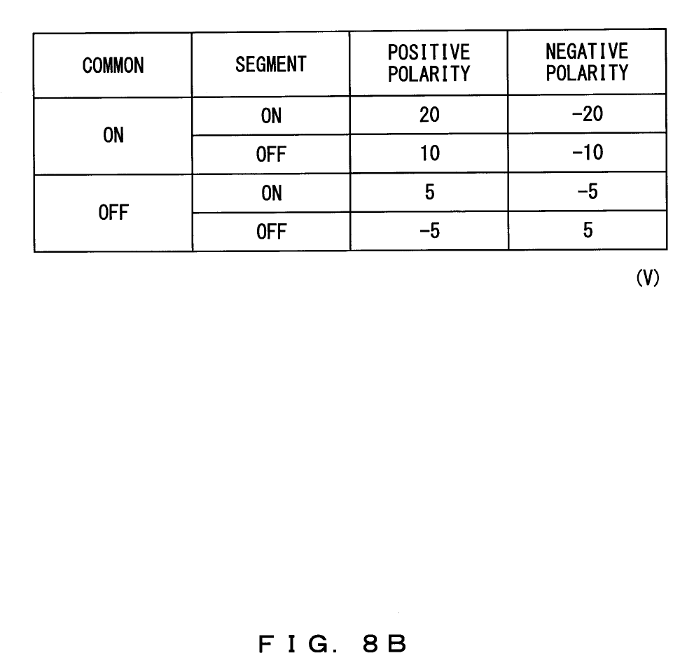

In a display apparatus using a cohlesteric liquid crystal, the column driver (segment driver) 27 and the row driver (common driver) 26 output, for example, pulses illustrated in FIG. 8A as gradation pulses applied to change the planer state to a halftone gradation gray level. By applying such pulses, voltages illustrated in FIG. 8B are applied to a pixel.

20V and 10V are supplied to the column driver as V0 and V21S & V34S, respectively, and as illustrated in FIG. 8A, positive and negative pulses are outputted in a positive phase (FR=1) and a negative phase (FR=0), respectively.

20V, 15V and 5V are supplied to the row driver as V0, V21C and V34C, respectively, and as illustrated in FIG. 8A, negative and positive pulses are outputted in a positive phase (FR=1) and a negative phase (FR=0), respectively.

By applying the pulses as illustrated in FIG. 8A, if a scan line is selected (a common driver is on) and also a data line is selected (a segment driver is on), 20V and −20V are applied in a positive phase (FR=1) and a negative phase (FR=0), respectively. If a scan line is selected (a common driver is on) and a data line is not selected (a segment driver is off), 10V and −10V are applied in a positive phase (FR=1) and a negative phase (FR=0), respectively. If a scan line is not selected (a common driver is off) and a data line is selected (a segment driver is on), 5V and −5V are applied in a positive phase (FR=1) and a negative phase (FR=0), respectively. If a scan line is not selected (a common driver is off) and also a data line is not selected (a segment driver is off), −5V and 5V are applied in a positive phase (FR=1) and a negative phase (FR=0), respectively. The row driver (FIG. 6) and common driver of this display apparatus can be composed of a general-purpose passive matrix driver IC. As the general-purpose passive matrix driver IC, an IC in which it can be selected as which it is used, a segment driver or a common driver depending to a voltage level applied to a terminal is also developed in addition to the segment and common driver ICs (For example, Seiko Epson-make STN liquid crystal driver S1D17A03/S1D17A04).

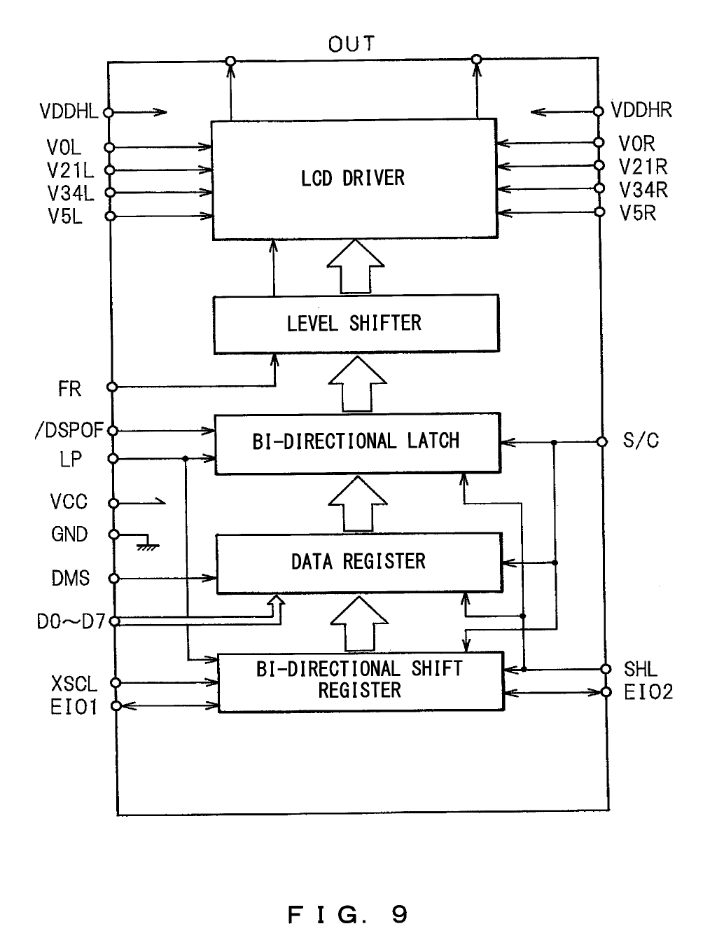

FIG. 9 illustrates a block configuration of a passive matrix driver IC with a mode selection function to select as which it is used, a segment driver or a common driver and its input/output signals.

Since this driver IC is used as both segment and common drivers, it includes a shift register, a data register and a latch.

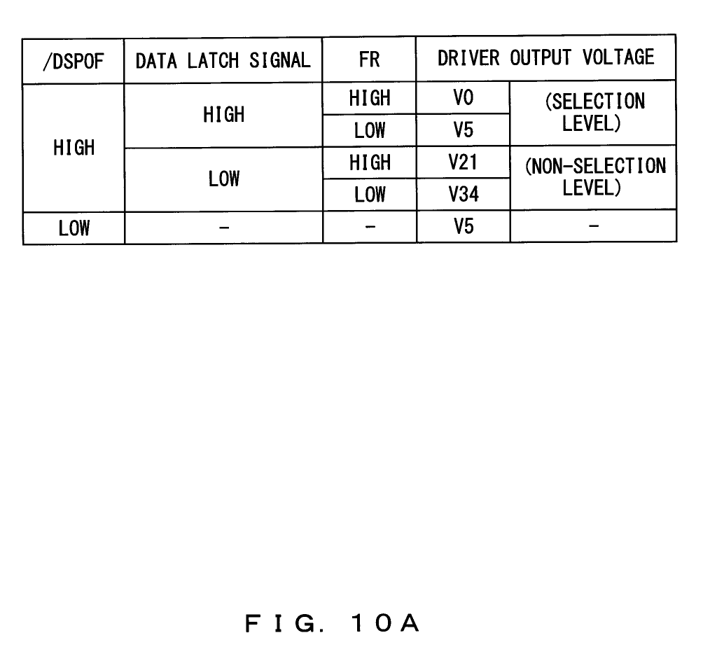

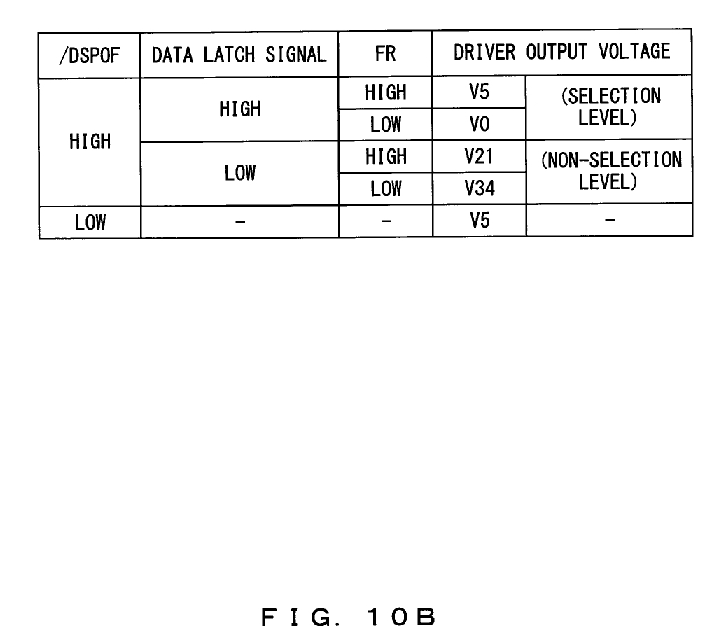

FIG. 10A illustrates the relationship between an input signal and an output voltage in the segment mode of the passive matrix driver IC with a mode selection function illustrated in FIG. 9.

As illustrated in FIG. 10A, if the display apparatus drive signal /DSPOF is “high (HIGH: 1)”, the driver in a segment mode outputs according to a data latch signal and if the display apparatus drive signal /DSPOF is “low (LOW: 0)”, the output becomes a predetermined value V5 (for example, GND). If the data latch signal is “1” and also the polarity control signal FR is “1”, it outputs V0 (20V) and if the data latch signal is “1” and the polarity control signal FR is “0”, it outputs the ground level V5 (GND). If the data latch signal is “0” and the polarity control signal FR is “1”, it outputs V21 (10V) and if the data latch signal is “0” and the polarity control signal FR is “0”, it outputs V34 (10V).

In this case, V0, V21 and V34 are voltages supplied from the outside to the driver and it is necessary to meet the restriction of V0≧V21≧V34≧GND.

FIG. 10B illustrates the relationship between an input signal and an output voltage in the common mode of the passive matrix driver IC with a mode selection function illustrated in FIG. 9.

As illustrated in FIG. 10B, if the display apparatus drive signal /DSPOF is “high (HIGH: 1)”, the driver in a common mode outputs according to a data latch signal and if the display apparatus drive signal /DSPOF is “low (LOW: 0)”, the output becomes a predetermined value V5 (for example, GND). If the data latch signal is “1” and also the polarity control signal FR is “1”, it outputs V5 (GND) and if the data latch signal is “1” and the polarity control signal FR is “0”, it outputs V0 (20V). If the data latch signal is “0” and the polarity control signal FR is “1”, it outputs V21 (15V) and if the data latch signal is “0” and the polarity control signal FR is “0”, it outputs V34 (5V). V0, V21 and V34 are voltages supplied from the outside to the driver and it is necessary to meet the restriction of V0≧V21≧V34≧GND.

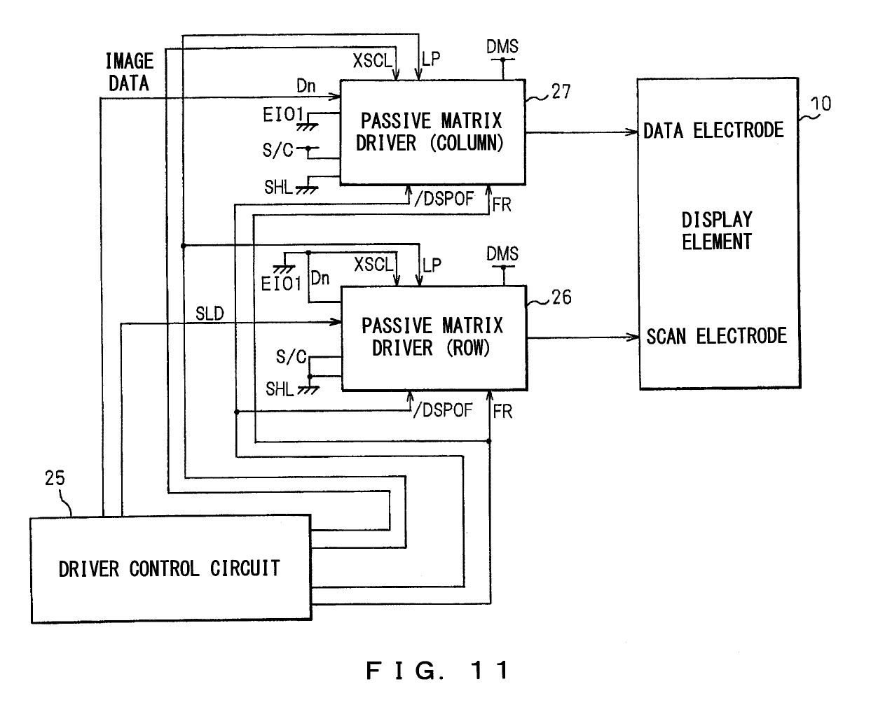

FIG. 11 is a block diagram illustrating the configuration of the display apparatus composed of the passive matrix driver IC with a mode selection function illustrated in FIG. 9. However, FIG. 11 illustrates only the display element 10, the driver control circuit 25, the row driver 26 composed of a passive matrix driver and the column driver 27 composed of a passive matrix driver, and the others are omitted in FIG. 11.

As illustrated in FIG. 11, the mode selection terminal S/C of the row driver 26 is connected to GND and also the row driver 26 is set to a common mode. The mode selection terminal S/C of the column driver 27 is connected to a HIGH terminal and also the column driver 27 is set to a segment mode. The pulse polarity control signal FR and the display apparatus drive signal /DSPOF are commonly inputted to the two drivers. The shift clock of image data and a data confirmation latch pulse are inputted to the XSCL and LP terminals, respectively, of the column driver 27. This data confirmation latch pulse is also inputted to the LP terminal of the row driver 26 and functions as a line shift clock. Image data is inputted to the data input terminals (D0-D7 in the case of 8-bit input) of the column driver 27. Scan line data SLD is inputted to the enable terminal EI01 of the row driver 26. In the normal scan operation, the SLD becomes 1 at the time of start and is maintained in 0 after that (the explanations of other terminals are omitted). Since each control signal is basically the same as that illustrated in FIG. 7, its detailed explanation is omitted.

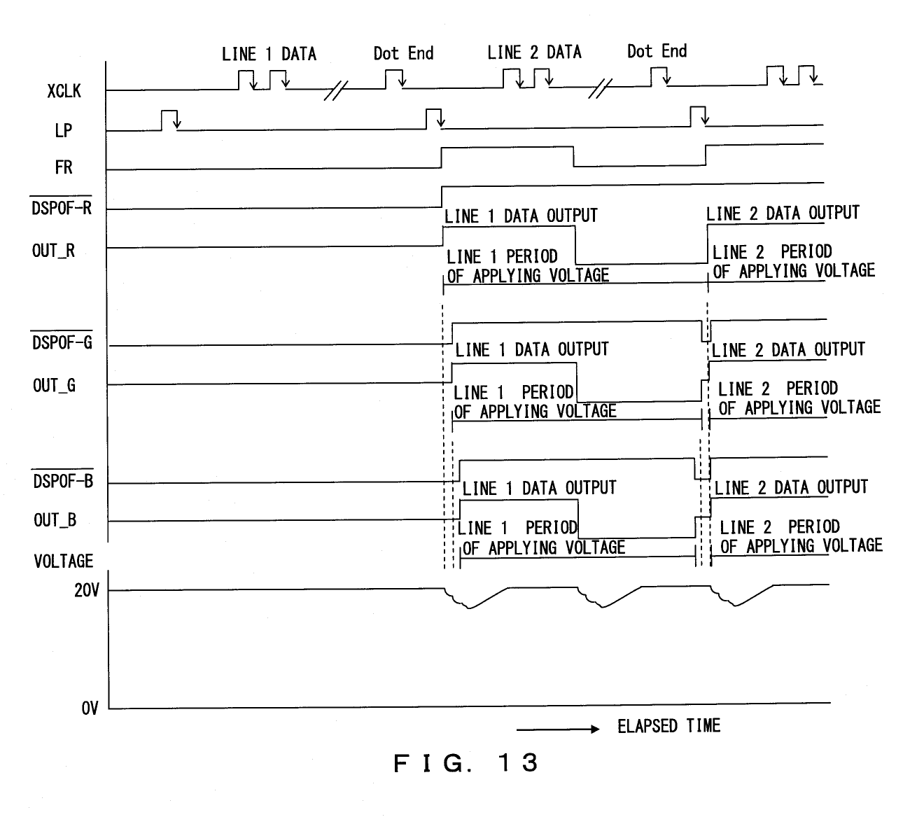

FIG. 13 is a time chart illustrating the sequence of the output signal of the passive matrix driver provided for a display apparatus according to the embodiment of the present invention.

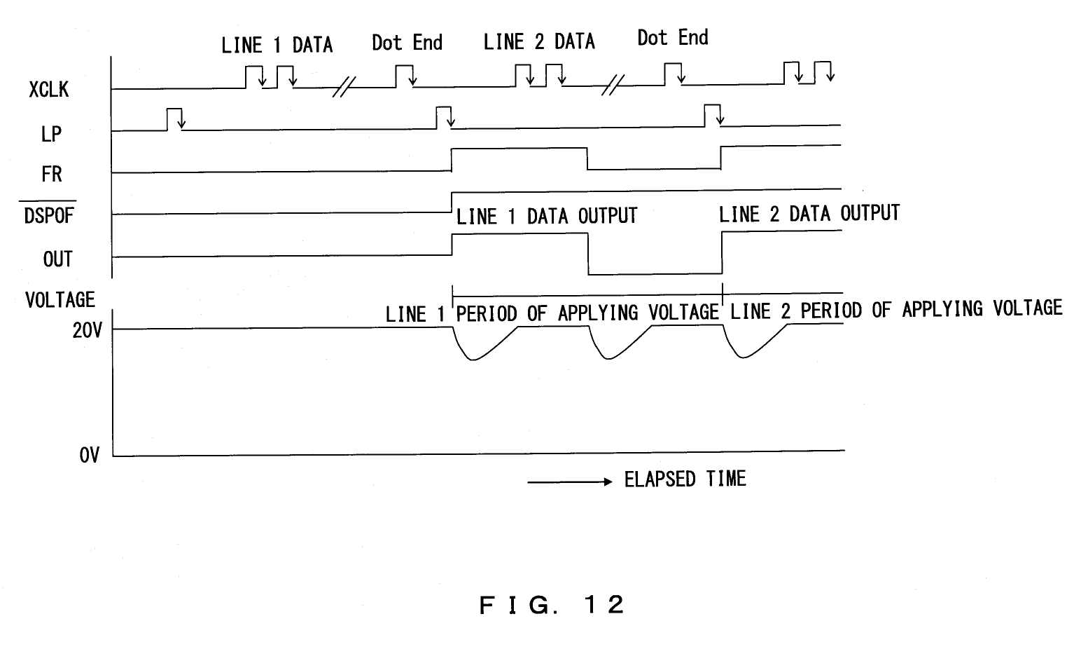

In FIG. 13, a pulse signal XCLK indicates a clock for retrieving data (see FIGS. 6 and 12). A pulse signal LP indicates a data confirmation latch pulse and a frame signal FR repeating cyclic rise and fall indicates a pulse polarity control signal for recovering time-varying degradation peculiar to a liquid crystal by inverting the polarity of the applied voltage. A display apparatus drive signal /DSPOF (DSPOF bar) is the drive signal of a liquid crystal display apparatus and more particularly it indicates the inverse signal of a compulsory off signal of the applied voltage (signal for switching off the applied voltage, that is, DSPOF) (see FIGS. 6 and 12). Furthermore, a data signal OUT indicates image data displayed on the liquid crystal display apparatus.

As illustrated in FIG. 13, the sequence of the output signals of a passive matrix driver provided for this embodiment, that is, the pulse signal XCLK indicating a data retrieving clock, the pulse signal LP indicating a data confirmation latch pulse and the frame signal FR indicating a pulse polarity control signal is the same as the sequence of the output signal of a general passive matrix driver illustrated in FIG. 12.

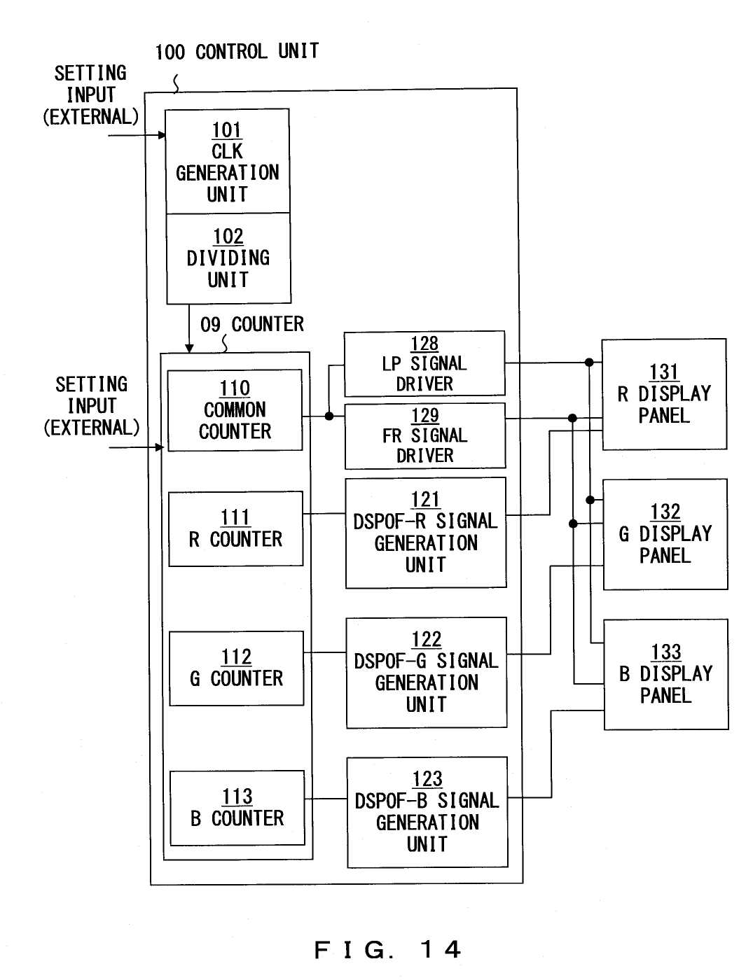

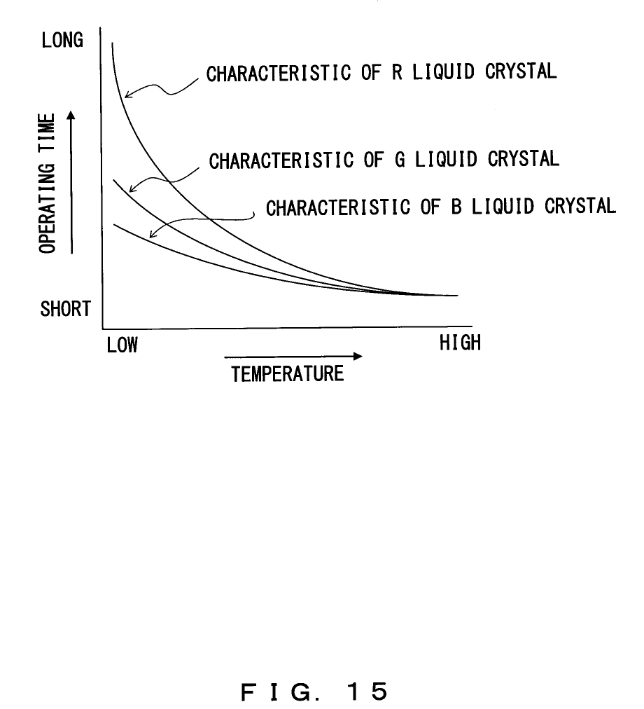

However, the output sequence of three display apparatus drive signals /DSPOF (DSPOF bar) supporting full-color display, that is, R, G and B (each of them indicates the drive signal pulse polarity control signal of the liquid crystal display) is interrupted by a time interval indicated by a predetermined setting value. This time interval is provided in order to compensate for the temperature-operating time characteristic of a nematic liquid crystal (FIG. 15) and can be set by the external input of the liquid crystal (FIG. 14) with reference to the temperature-operating time characteristic of the nematic liquid crystal, which will be described later. Conventionally, since voltage is applied to each liquid crystal for the same time regardless of the characteristic of each liquid crystal, power is consumed more than required. However, by applying the present invention, the application time of voltage can become controlled on the basis of the characteristic of each liquid crystal, thereby saving power compared with the conventional one.

Furthermore, conventionally, since all liquid crystals are simultaneously driven, under shoot in which voltage (20V) for driving a liquid crystal at the initial time temporarily decreases occurs and thereby the display contrast becomes unstable. Meanwhile, by applying the present invention, the above-described under shoot can be suppressed to a minimum level. Therefore, its influence on the display contrast can be suppressed to a low level.

As illustrated in FIG. 15, in each ambient temperature, as to the operating speed of a nematic liquid crystal, R (for red), G (for green) and B (for blue) are the lowest, secondly-low and the highest, respectively. Therefore, the rise of the display apparatus drive signal /DSPOF (DSPO bar)-R for controlling the R (for red) display apparatus (panel) is preceded, then the display apparatus drive signal /DSPOF (DSPO bar)-G is raised and lastly the display apparatus drive signal /DSPOF (DSPO bar)-B is raised.

FIG. 14 is a block configuration from the functional point of view, of the driver control circuit 25 provided for a display apparatus according to the embodiment of the present invention.

In FIG. 14, a control unit 100 is a block from the functional point of view, of the driver control circuit 25 provided for a display apparatus according to the embodiment of the present invention.

The control unit 100 includes a CLK (clock) generation unit 101 for generating a pulse signal CLK capable of setting a cycle by an external input, a dividing unit 102 for dividing the pulse signal CLK and a counter 109 including a common counter 110, an R counter 111, a G counter 112 and a B counter 113 and also counting sequence control timing on the basis of the output pulse of the dividing unit 102.

The control unit 100 further includes an LP signal driver 128 for receiving the output (timing) of the common counter 110 and outputting a pulse signal LP, an FR signal driver 129 for outputting a frame signal FR, an R drive signal generation unit 121 for receiving the output (timing) of the R counter 111 and outputting the display apparatus drive signal /DSPOF (DSPOF bar)-R, a G drive signal generation unit 122 for receiving the output (timing) of the G counter 112 and outputting the display apparatus drive signal /DSPOF (DSPOF bar)-G and a B drive signal generation unit 123 for receiving the output (timing) of the B counter 113 and outputting the display apparatus drive signal/DSPOF (DSPOF bar)-B.

The outputs of the LP signal driver 128 and the FR signal driver 129 are inputted to an R display panel 131, a G display panel 132 and a B display panel 133. The outputs of the R drive signal generation unit 121, the G drive signal generation unit 122 and the B drive signal generation unit 123 are inputted to the R display panel 131, the G display panel and the B display panel 133, respectively. It is assumed that the output timing (sequence) of the LP signal driver 128 and the FR signal driver 129 is as illustrated in FIG. 13. The above-described three display panels are piled on each other.

Each of the time interval (delay time) in output (timing) between the R drive signal generation unit 121 and the G drive signal generation unit 122 and the time interval (delay time) in output (timing) between the G drive signal generation unit 122 and the B drive signal generation unit 123 can be set by an external input. Information being the base of this setting (temperature-operating time characteristic of the nematic liquid crystal) will be explained below.

As illustrated in FIG. 13, since the block (control unit 100) from the functional point of view of the driver control circuit 25 provided for the display apparatus according to this embodiment includes one set of the CLK (clock) generation unit 101 for generating a pulse signal CLK, the LP signal driver 128 for outputting a pulse signal LP and the FR signal driver 129 for outputting a frame signal FR, in other words, it is simplified in order to be shared by three primary colors (R, G and B), the manufacturing cost (variable cost) can be remarkably reduced compared with the conventional driver control circuit. Furthermore, since as to the display apparatus drive signal (/DSPOF), a dedicated circuit is provided for each of the three primary colors (R, G and B) and it is generated with a peculiar suitable timing, the occurrence of color shift/unevenness (chromatic aberration) in a display image can be prevented.

FIG. 15 is a graph illustrating the temperature-operating time characteristic of a general nematic liquid crystal.

As illustrated in FIG. 15, a general nematic liquid crystal has such a temperature-operating time characteristic that an operating time decreases (namely, the operating speed increases) as the ambient temperature increases. Furthermore, since as to this operating speed, R (for red), G (for green) and B (for blue) are the lowest, secondly-low and the highest, respectively, in the control sequence illustrated in FIG. 13, the rise of the display apparatus drive signal /DSPOF (DSPOF bar)-R for controlling the R (for red) display (panel) is preceded, then the display apparatus drive signal /DSPOF (DSPOF bar)-G is raised and lastly the display apparatus drive signal/DSPOF (DSPOF bar)-B is raised.

Although as to the time interval (delay time) in output (timing) between the R drive signal generation unit 121 and the G drive signal generation unit 122 and the time interval (delay time) in output (timing) between the G drive signal generation unit 122 and the B drive signal generation unit 123, FIG. 15 can be referenced and be determined in conformity with the ambient temperature (room temperature or the like) in the operating environment of this liquid crystal display apparatus. As understood from FIG. 15, the chromatic aberration preventive effect of the liquid crystal display according to the embodiment of the present invention becomes remarkable as the ambient temperature increases.

Thus, in the liquid crystal display according to the embodiment of the present invention capable of supporting full-color display too, one set of control signals composed of a pulse signal XCLK indicating a data retrieving clock, a pulse signal LP for indicating a data confirmation latch pulse and a frame signal FR indicating a pulse polarity control signal are shared by R (for red), G (for green) and B (for blue). Therefore, the required number of components can be widely reduced compared with the conventional liquid crystal display, thereby remarkably reducing the cost.

Furthermore, in the liquid crystal display according to the embodiment of the present invention since as to the control sequence of the display apparatus drive signal /DSPOF (DSPOF bar), control sequence can be set in relation to the R (for red), G (for green) and B (for blue) nematic liquid crystals taking into consideration the temperature-operating time characteristic of the nematic liquid crystal, the color shift/unevenness (chromatic aberration) can be accurately solved.

1. A display provided with a matrix display element, a row driver for driving a scan electrode of the display element, a column driver for driving a data electrode of the display element, comprising:
a unit for outputting one set of control signals composed of a pulse signal XCLK indicating a clock for retrieving data, a pulse signal LP indicating a latch pulse for data confirmation and a frame signal FR indicating a pulse polarity control signal; and
a unit for sequentially outputting a display apparatus drive signal (/DSPOF-R), a display apparatus drive signal (/DSPOF-G) and a display apparatus drive signal (/DSPOF-B) each with different timing as three display apparatus drive signals supporting full-color display and also inputting the signals into three liquid crystal display apparatuses corresponding to three liquid crystal panels supporting full-color display.

2. The display according to claim 1, wherein
each of an output time interval between the display apparatus drive signal (/DSPOF-R) and the display apparatus drive signal (/DSPOF-G) and an output time interval between the display apparatus drive signal (/DSPOF-G) and the display apparatus drive signal (/DSPOF-B) can be set.

3. The display according to claim 1, wherein
each of the three display apparatus drive signals corresponds to two high or low values of the signal and starts or stops drive of a corresponding liquid crystal display apparatus.

4. The display according to claim 3, wherein
each of the three display apparatus drive signals validates a voltage applied to the corresponding liquid crystal display apparatus when the signal is high and compulsorily eliminates a voltage applied to the corresponding liquid crystal display apparatus when the signal is low.

5. The display according to claim 2, wherein
the output time intervals are set with reference to a temperature-operating time characteristic of a nematic liquid crystal used in the liquid crystal display apparatus and an ambient temperature in a setting environment of the liquid crystal display apparatus.

6. The display according to claim 1, wherein
three liquid crystal display panels corresponding to the three liquid crystal display apparatuses controlled by the three display drive signals, respectively are piled on each other.
